(19) United States
(12) Patent Application Publication
(10) Pub. No.: US 2025/0181667 A1
(43) Pub. Date: Jun. 5, 2025

(54) HARDWARE ACCELERATION OF CLIFFORD ALGEBRAIC OPERATIONS

(71) Applicant: Intel Corporation, Santa Clara, CA (US)

(72) Inventors: Margarita Jauregui Franco, Japopan (MX); Rodrigo Aldana Lopez, Zapopan (MX); Julio Cesar Zamora Esquivel, West Sacramento, CA (US); Lama Nachman, Santa Clara, CA (US)

(73) Assignee: Intel Corporation, Santa Clara, CA (US)

(21) Appl. No.: 19/047,303

(22) Filed: Feb. 6, 2025

(51) Int. Cl. G06F 17/11

(52) U.S. Cl. CPC G06F 17/11

(57) ABSTRACT

An apparatus may compute geometric products of blades. The apparatus may include a register, sign compute block(s), parity block(s), and an XOR gate. The register may store a first bit operand representing which base(s) are included in a first blade and a second bit operand representing which base(s) are included in a second blade. The sign compute block(s) may determine one or more signs from the bit operands. A sign may indicate whether a product of multiplying base(s) in the first blade by base(s) in the second blade is positive or negative. Each parity block is paired with a sign compute block. Each parity block may determine whether to change a sign determined by the pairing sign compute block. The XOR gate may determine a sign for the geometric product of the first blade and the second blade from outputs of the sign compute block(s) and the parity block(s).

### TECHNICAL FIELD

This disclosure relates generally to deep learning, and more specifically, hardware acceleration of geometric algebraic operations (also referred to as “Clifford algebraic operations”), such as geometric algebraic operations in geometric deep learning.

### BACKGROUND

Geometric algebra, also called “Clifford algebra,” is a tool for handling objects of various dimensions (e.g., scalars, vectors, planes, and other dimensional constructs) within a unified algebraic structure. Geometric Deep Learning (GDL) is a branch of machine learning. GDL typically focuses on leveraging geometric structures and principles to improve the performance and interpretability of deep learning models. It can generalize deep learning techniques to non-Euclidean domains, such as graphs, manifolds, and other geometric spaces. GDL has applications in various fields, including computer vision, natural language processing, drug discovery, and so on. It can provide a unified framework to study and develop neural network architectures that can handle complex geometric data.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a geometric algebra system, in accordance with various embodiments.

FIG. 2 illustrates base representation mapping of blades in a geometric algebraic operation, in accordance with various embodiments.

FIG. 3 illustrates a hardware accelerator, in accordance with various embodiments.

FIG. 4 illustrates an example sign computation, in accordance with various embodiments.

FIGS. 5A-5G illustrate a sign compute unit with a mask decoder and one-hot decoder, in accordance with various embodiments.

FIG. 6 illustrates a sign compute unit including sign compute blocks paired with parity blocks, in accordance with various embodiments.

FIG. 7 illustrates a hardware accelerator including a 4-bit sized sign compute block, in accordance with various embodiments.

FIG. 8 illustrates a sign compute block including a 1-bit sized sign compute block, in accordance with various embodiments.

FIG. 9 illustrates a sign compute unit with a cascade block topology, in accordance with various embodiments

FIGS. 10A and 10B illustrate a parity block, in accordance with various embodiments.

FIG. 11 is a flowchart of a method of executing a geometric algebraic operation, in accordance with various embodiments.

FIG. 12 is a block diagram of an example computing device, in accordance with various embodiments.

### DETAILED DESCRIPTION

### Overview

Geometric algebra is a powerful tool for handling objects of various dimensions (such as scalars, vectors, planes, higher-dimensional constructs, etc.) within a unified algebraic structure. It is widely used in fields such as computer graphics, robotics, physics, and engineering to solve spatial and transformation problems. There can be an impact of geometric algebra in the growing area of GDL, a new machine learning paradigm that leverages meaningful geometric features of data. Currently available algorithms are based on central processing units (CPUs) or graphics processing units (GPUs) and use tensors on linear algebra for different applications like deep learning, graphics, physics engines, and more. However, tensor-based transformations are usually inefficient and affected by the sparsity of data. Geometric algebra can make such operations more efficient by reducing ˜16× the number of operations. Geometric algebra uses the geometric algebras to operate the multi-vector's blades, and such operations depend on the signature of the geometry.

A pipeline of geometric algebraic operations usually relies heavily on the geometric product (also referred to as “Clifford product”), with the computation of the sign of the resulting product being a critical bottleneck due to its complex relationship with the inputs. A geometric product may be the product of multiplying a blade by one or more other blades in the geometric algebraic operation. A blade may be the result of multiplying two or more bases. In addition to the bases, a blade may also include a scalar. A blade may also be the result of multiplying a blade by a scalar. The geometric algebraic operation may have a predetermined number of bases. The square of each base is either 1 or −1. A blade in the geometric algebraic operation may include one or more of these bases.

Currently, there are a few solutions that enable relatively fast computation of geometric algebraic operations when compared to performing the calculations manually. These solutions are typically based on CPUs, GPUs, or hardware accelerators. Currently available CPUs can handle geometric algebraic operations through dedicated software libraries. However, the hardware and instruction sets are typically not optimized for this specific task. Their general-purpose design leads to inefficiencies, especially when dealing with the complex operations required in GDL, where real-time processing and scalability are crucial.

GPUs can offer parallel processing capabilities and can accelerate certain aspects of geometric algebra computations. However, they are primarily optimized for tasks with specific spatial and temporal locality and symmetries, common in graphics and general machine learning. In the context of GDL, where operations often require a broader scope and more complex transformations, GPUs may not provide the optimization, especially for critical tasks like computing the geometric product's sign.

Currently available hardware accelerators are typically designed for specific tasks, such as those in graphics or robotics, and are optimized for operations with well-defined locality and symmetry. However, these accelerators are not tailored for the broader and more complex operations found in geometric algebra, which are essential for GDL. As a result, they fall short in delivering the required performance and efficiency in this emerging field. Current Math Libraries use Look-Up tables to accelerate the computation, but this is not a scalable solution for high dimensional problems like pattern recognition using deep learning.

Embodiments of the present disclosure may improve on at least some of the challenges and issues described above by accelerating geometric algebraic operations by using hardware with scalability and flexibility. In an example, a hardware acceleration in the present disclosure includes sign compute blocks paired with parity blocks to determine signs of geometric products of blades.

In various embodiments of the present disclosure, an apparatus may execute a geometric algebraic operation, including multiplications of blades in the geometric algebraic operation. The geometric algebraic operation may have a n-dimensional space, indicating that the total number of bases in the geometric algebraic operation is n. n indicates a dimension of the vector space of the geometric algebraic operation. n may be the sum of p and q, each of which may be an integer, where p bases out of the n bases have squares equal to 1 and q bases out of the n bases have squares equal to −1. A blade may include one or more of the n bases. For each blade in the geometric algebraic operation, a bit operand may be generated. The bit operand may have be a n-dimensional bit array that includes a sequence of n bits. The n bits correspond to the n bases, respectively. Each bit indicates whether the corresponding base is present in the blade or not. For instance, a high bit (i.e., 1) may indicate that the corresponding base is present in the blade, while a low bit (i.e., 0) may indicate that the corresponding base is absent from the blade.

The apparatus may include a register that stores a first bit operand for a first blade of the geometric algebraic operation and stores a second bit operand for a second blade of the geometric algebraic operation. The register may be coupled to one or more sign compute blocks and one or more parity blocks in the apparatus. Bits in the first bit operand and second bit operand can be transmitted to the one or more sign compute blocks and one or more parity blocks through buses. The sign compute block(s) may determine, from the first bit operand and the second bit operand, one or more signs. A sign determined by a sign compute block may indicate whether a product of multiplying one or more bases in the first blade by one or more bases in the second blade is positive or negative. Each parity block may be paired with a sign compute block. A parity block may determine a parity which indicates whether to change a sign determined by a sign compute block with which the parity block is paired. The apparatus may also include an XOR gate (also referred to as “XOR logic gate”) may output a signal from outputs of the sign compute block(s) and the parity block(s). The signal indicates a sign of a geometric product of the first blade and the second blade.

The sign compute block(s) may each have a size of l bits, meaning the sign compute block can process l bits from the first bit operand and l bits from the second bit operand at a time. l is an integer that is greater than 0 and smaller than n. The apparatus may include m sign compute block(s) and m parity blocks, where n=m×l. In an example, the sign compute block(s) may be 1-bit sized sign compute block(s), and the apparatus may have a cascade, sequential topology in which n sign compute block(s) are wired to n parity blocks. Such an architecture of the hardware apparatus can provide scalability and flexibility that are not available in currently available solutions. Various designs and operational modes can be built with such sign compute blocks.

This disclosure provides a hardware apparatus designed to efficiently compute the sign resulting from the geometric product between at least two blades or multi-vectors. Given the scalability and flexibility, various architectures of the hardware apparatus are applicable. The solution in this disclosure is pertinent to integrating this hardware into a larger product. This parameterizable circuit can be part of a robust and scalable accelerator for geometric algebras, significantly enhancing the performance of existing hardware by providing a specialized unit for these operations.

In an n-dimensional space, the complexity is O(n), meaning the operation requires either n clock cycles for a sequential approach or a hardware size that increases linearly with n for a combinational approach. The solution in this disclosure can leverage the algebraic structure of the geometric product to maximize hardware efficiency. The computation may rely on a carefully structured, recursively arranged interconnection of XOR gates (e.g., XOR gates in sign compute blocks or parity blocks), which is one of the nontrivial and novel aspects of this disclosure. The hardware in this disclosure can scale with the dimensionality of the geometry. It can be optimized for the complete computation of geometric product operations.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or hardware accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

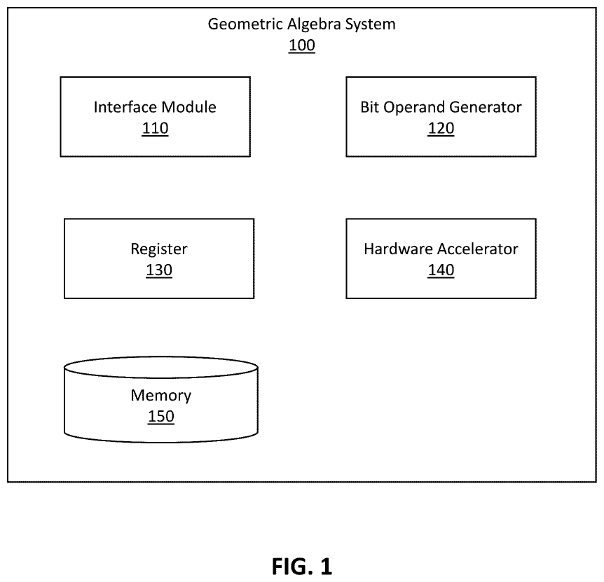

FIG. 1 is a block diagram of a geometric algebra system 100, in accordance with various embodiments. The geometric algebra system 100 can execute geometric algebraic operations, such as geometric algebraic operations in GDL. The geometric algebra system 100 includes an interface module 110, a bit operand generator 120, register 130, hardware accelerator 140, and a memory 150. In other embodiments, alternative configurations, different or additional components may be included in the geometric algebra system 100. For instance, the register 130 or memory 150 may be part of the hardware accelerator 140. Further, functionality attributed to a component of the geometric algebra system 100 may be accomplished by a different component included in the geometric algebra system 100 or a different module or system.

The interface module 110 facilitates communications of the geometric algebra system 100 with other modules or systems. In some embodiments, the interface module 110 may receive information of geometric algebraic operations to be executed by the geometric algebra system 100. A geometric algebraic operation may be an operation involving a plurality of basis elements (also referred to as “basis vectors” or “bases”). In some embodiments, a geometric algebraic operation may be characterized by two parameters denoted as p and q. p may be the number of bases whose square equals to 1. q may be the number of bases whose square equals to −1. Each base may be denoted et, where i is the component within the p and q range. In an example, a geometric algebraic operation may have n bases denoted as e₀, e₁, . . . , eₙ₋₁, where n=p+q. n indicates the dimension of the vector space of the geometric algebraic operation.

Bases may comply with signature contractions, which may be denoted as:

$${e}_{i}^{2} = {e}_{i} {e}_{i} = \{ \begin{matrix}1 for i = 0 , … , p - 1 \\ - 1 for i = p , … , p + q - 1\end{matrix} ,$$

where eᵢeᵢ denotes the square of base eᵢ. Bases may comply with an antisymmetric property that may be denoted as:

eᵢeⱼ=−eⱼeᵢ,

where eᵢeⱼ denotes a geometric product operation. Different values of i and j may result in a composed base eᵢeⱼ=eᵢⱼ. For any p, q bases, the resulting algebra may have 2^{p+q} bases.

A blade may be a product of multiple vectors. A vector may be a basis vector eᵢ or a scalar vector. A scalar vector may be a value. Different blades may have different bases. Examples of blades include e₁, e₂e₁, e₅e₃e₄e₂, 3e₁, 9e₂e₁, and so on. The blade of greatest degree may be e₀e₁ . . . eₙ₋₁. A multi-vector is a linear combination of blades. For example, 1+2e₂+5e₁+e₅e₃e₄e₂−9e₂e₁ is a multi-vector. 1+2e₂ is also a multi-vector. The computation of the product of multi-vectors may come into resolving the product of two blades, more specifically, the resulting sign.

A sign change may occur in various scenarios. In an example scenario of a base contracts to −1 (e.g., negative square eᵢ²=−1): e₃²e₁²e₀=(−1)(+1)e₀=−e₀. In another example scenario of swapping bases to complete a contraction: e₂e₁e₀e₃e₂=−e₂e₁e₀e₂e₃ by changing e₃e₂ to e₂e₃; further −e₂e₁e₀e₂e₃=+e₂e₁e₂e₀e₃ by swapping e₀e₂ to e₂e₀; next +e₂e₁e₂e₀e₃=−e₂²e₁e₀e₃ by changing e₁e₂ to e₂e₁. In yet another example scenario of swapping bases for recording purpose: e₀e₃e₂e₁=−e₃e₀e₂e₁ by swapping e₀ and e₃; next −e₃e₀e₂e₁=+e₃²e₀e₁ by swapping e₀ and e₂; further +e₃e₂e₀e₁=−e₃e₂e₁e₀ by swapping e₀ and e₁.

Some scenarios (such as the second scenario and third scenario described above) are directly related to the anti-symmetrical property. Every time two bases are swapped, the negative of the previous version of the blade is obtained, which is equivalent to multiplying by −1 on each swap. An even number of swaps may lead to no sign change, while an odd number of swaps may lead to a sign change. Such sign computation may be achieved by the hardware accelerator 140 described below.

The multiplication of two or more multi-vectors is another multi-vector. In an example where n=p=4:

$$( 1 + {e}_{1} + 2 {e}_{1} {e}_{2} ) ( {e}_{2} {e}_{3} - {e}_{1} {e}_{2} {e}_{3} ) = {e}_{2} {e}_{3} + {e}_{1} {e}_{2} {e}_{3} + 2 {e}_{1} {e}_{2} {e}_{2} {e}_{3} - {e}_{1} {e}_{2} {e}_{3} - {e}_{1} {e}_{1} {e}_{2} {e}_{3} - 2 {e}_{1} {e}_{2} {e}_{1} {e}_{2} {e}_{3} = {e}_{2} {e}_{3} + 2 {e}_{1} {e}_{3} - {e}_{2} {e}_{3} + 2 {e}_{3} .$$

In some embodiments, all geometric operations, such as dot and wedge products, can be obtained from the more general geometric product of multi-vectors.

The bit operand generator 120 generates bit operands for blades of geometric algebraic operations. A bit operand may be a representation of a blade. In some embodiments, a bit operand includes a sequence of bits that indicates presence or absence of bases in a blade. In some embodiments, the total number of bits in the bit operand may equal n. Each bit may correspond to a different base and indicate whether the blade has the base.

In some embodiments, a bit set to ‘1’ indicates that the base is included in the blade, while a ‘0’ bit indicates that the base is not included in the blade. This binary representation efficiently captures all possible base combinations within a blade. To implement this algorithm in hardware, the notation may be adjusted to meet hardware requirements, but the core functionality can remain unchanged. These changes are purely for hardware compatibility and do not affect the operation's logic. A binary word full of zeros represents a scalar, a binary word [0 . . . 01] represents the first basis vector e₀, the word [0 . . . 011] represents the product e₂e₁, and so on.

This representation allows for efficient resolution of the resulting bases after the product using a simple XOR operation. For example, the bit operand for e₃e₁e₀ is [01011], the bit operand for e₄e₃e₀ is [11001], and the bit operand for e₄e₁ is [10010]. Where repeated basis is eliminated due to contractions to 1 or −1. However, computing the resulting sing of the product of blades is still nontrivial in this case.

In some embodiments, the bit operand generator 120 may determine an order of bases in blades for generating bit operands for the blades. In an example, the order may be an ascending order, meaning the index i of the first base in the blade is the lowest and the index i of the last base in the blade is the highest. In another example, the order may be a descending order, meaning the index i of the first base in the blade is the highest and the index i of the last base in the blade is the lowest. The bit operand generator 120 may rearrange the bases in a blade when the original order of the bases does not match the order determined by the bit operand generator 120. For instance, when the bit operand generator 120 selects the ascending order, the bit operand generator 120 may change e₄e₁ to e₁e₄ by swapping e₄ and e₁. The bit representations of both e₄e₁ and e₁e₄ may be stored as [10010].

The register 130 stores bit operands generated by the bit operand generator 120. In some embodiments, the register 130 may store a pair of bit operands at a time, e.g., for computing the product of two blades. The bit operand of one of the blades may be stored in a first portion of the register 130, and the bit operand of the other blade may be stored in a second portion of the register 130. For instance, the first bit operand may be stored as the most significant bits in the register 130, and the second bit operand may be stored as the lowest significant bits in the register 130. The dimension of the register 130 (e.g., the total number of bits that the register can store) may be 2n. In other embodiments, the register 130 may store more bit operands at a time, or the geometric algebra system 100 may include multiple registers.

In some embodiments, a bit operand stored in a register may be updated during the computation of the geometric product. For instance, at least part of the first bit operand may be replaced with at least part of a new bit operant computed from the first bit operand and the second bit operand. This new bit operant may be a bit operand of the geometric product. The second bit operand in the register 130 may remain the same.

The hardware accelerator 140 executes geometric algebraic operations. A geometric algebraic operation may include one or more multiplications of blades. The product of two or more blades is referred to as a geometric product. A geometric product may be a blade, which may be referred to as a resulting blade of the geometric algebraic operation. In some embodiments, the hardware accelerator 140 performs sign computations in geometric algebraic operations. A sign computation may be a computation of a sign of a geometric product. The hardware accelerator 140 may also compute the absolute resulting blade. The sign and the absolute resulting blade may constitute the geometric product.

In some embodiments, the hardware accelerator 140 may multiply blades (e.g., two blades) by multiplying their scalar coefficients, computing the XOR of their binary representation, and computing the resulting sign. The hardware accelerator 140 may include one or more multipliers that can multiply scaler coefficients. The hardware accelerator 140 may include one or more XOR logic gates that can compute the XOR of binary representations of blades. The hardware accelerator 140 may include one or more components that implement one or more sign computation algorithms. As described above, the sign of a product of blades can change due to various scenarios. Sign computation algorithms implemented by the hardware accelerator 140 may detect and resolve these scenarios.

In an example, the hardware accelerator 140 may perform three steps to determine a sign of a geometric product. In the first step, the hardware accelerator 140 may detect whether there is a match between the blades, e.g., whether the blades have the same base. For example, there is a match when two blades both include e₂. A match may indicate a contraction, which may trigger a need to identify whether the base contract to 1 or −1. In the second step, the hardware accelerator 140 may determine the amount of swaps needed to take the desired bases to the contraction position when there is a match between bases. In some embodiments, the hardware accelerator 140 may determine the amount of swaps by determining how many bases are located between the two corresponding bases. The hardware accelerator 140 may determine that there is no sign change where there are an even number of swaps and determine that there is a sign change where there are an odd number of swaps. In the third step, the hardware accelerator 140 may perform one or more additional swaps to reorder the remaining bases into a resulting single blade. The third step may be performed after the contractions in the first step and the swapping in the second step were already performed. In some embodiments, the hardware accelerator 140 may perform the third step by calculating the number of bases that separate each base's current location from its intended final location and using this information to guide the sign calculation process.

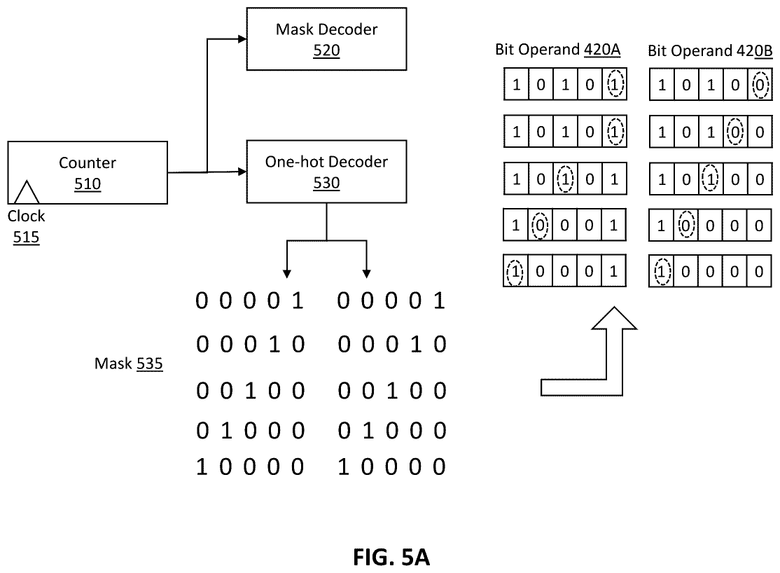

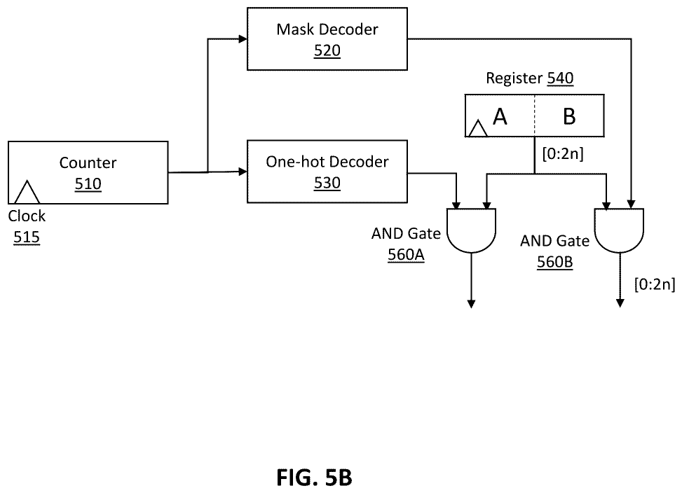

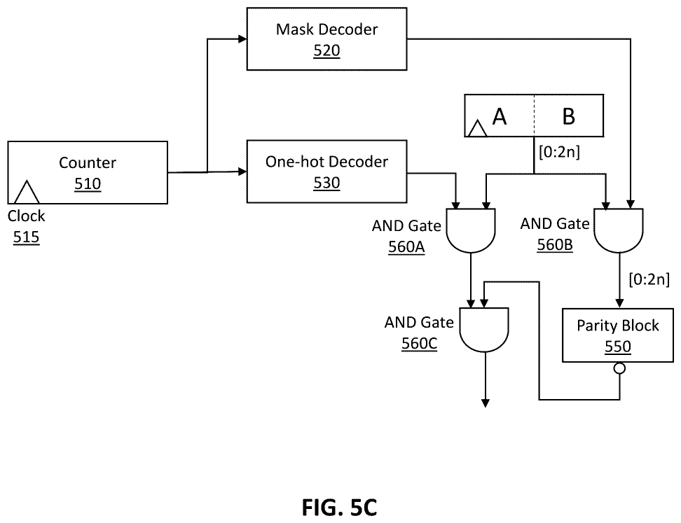

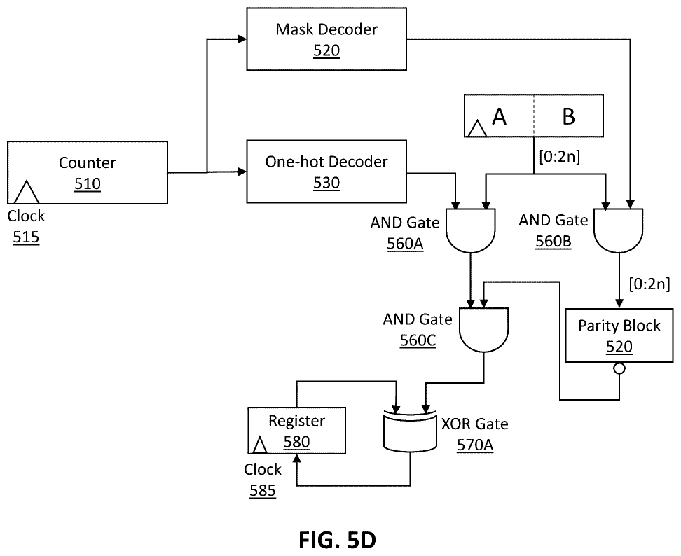

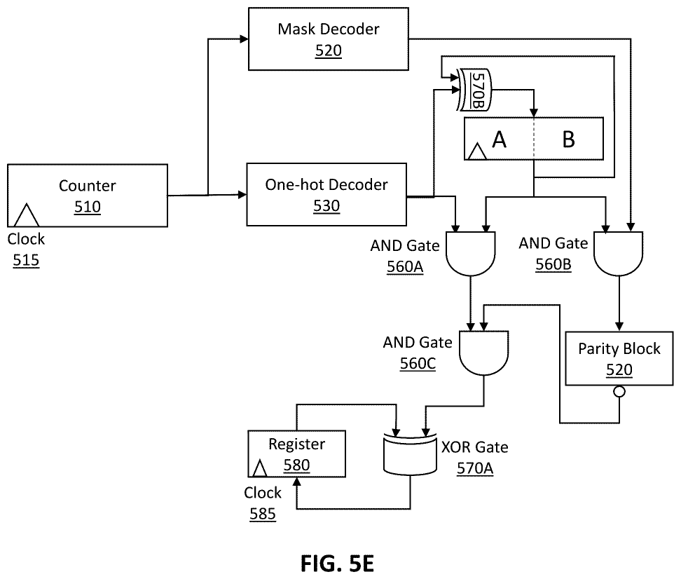

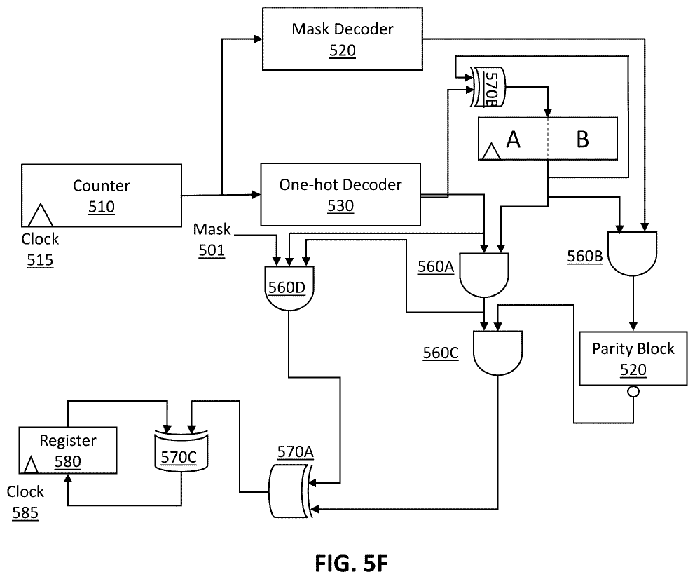

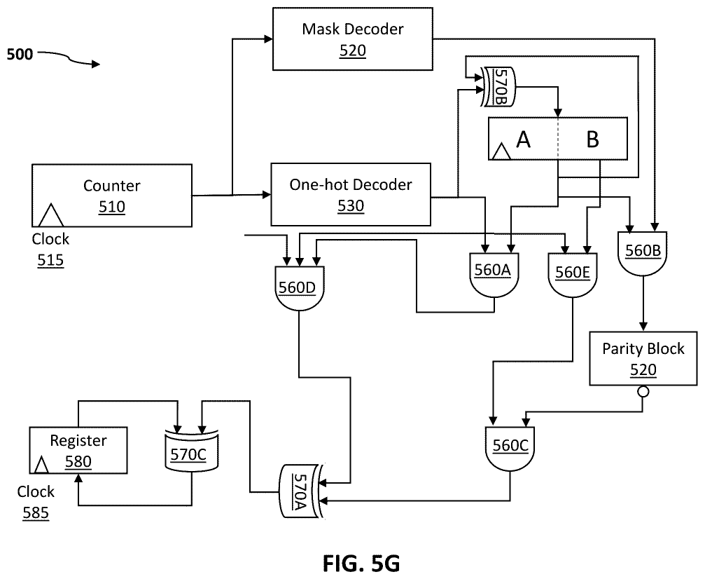

In some embodiments, after the hardware accelerator 140 performs the three steps, the hardware accelerator 140 may monitor for any changes in sign. For instance, the hardware accelerator 140 may keep track of the current value of the sign and update it as needed. The hardware accelerator 140 may have various architectures in various embodiments to implement sign computation algorithms. Certain aspects of these architectures are described below in conjunction with FIGS. 5-10.

The memory 150 stores data received, generated, used, or otherwise associated with the geometric algebra system 100. For example, the memory 150 stores data received by the interface module 110. The memory 150 may also store data generated by the bit operand generator 120 or hardware accelerator 140. For instance, the memory 150 may store blades, bit operands, geometric products, and so on. In the embodiment of FIG. 1, the memory 150 is a component of the geometric algebra system 100. In other embodiments, the memory 150 may be external to the geometric algebra system 100 and communicate with the geometric algebra system 100 through a network.

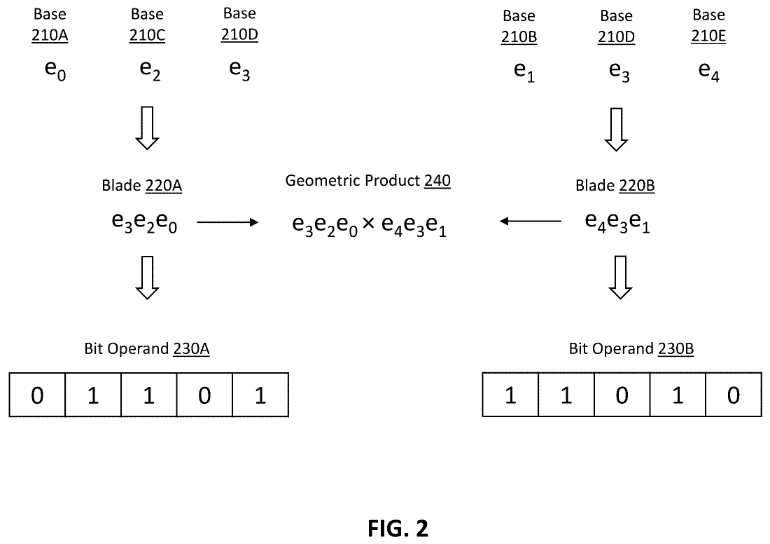

FIG. 2 illustrates base representation mapping of blades in a geometric algebraic operation, in accordance with various embodiments. For the purpose of illustration and simplicity, FIG. 2 shows five bases 210A-210D in the geometric algebraic operation. In some embodiments, one or more parameters (e.g., n, p, or q) of the geometric algebraic operation equal 5. Three bases 210A, 210C, and 210D are included in a blade 220A. Three bases 210B, 210D, and 210E are included in another blade 220B. The geometric algebraic operation includes a multiplication of the blade 220A by the blade 220B, which results in a geometric product 240. The geometric product 240 is a blade itself.

The blade 220A has a bit operand 230A. The bit operand 230A may be generated from the blade 220A, e.g., by the bit operand generator 120 in FIG. 1. The bit operand 230A has 5 bits. The bits may correspond to the five possible bases of the geometric algebraic operation: e₀, e₁, e₂, e₃, and e₄, respectively. A bit of one indicates that the corresponding base is present in the blade 220A. A bit of zero indicates that the corresponding base is absent from the blade 220A. As the blade 220A has e₃, e₂, and e₀, the second bit (corresponding to e₃), third bit (corresponding to e₂), and fifth bit (corresponding to e₀) in the bit operand 230A are one, and the first bit (corresponding to e₄) and fourth bit (corresponding to e₁) in the bit operand 230A are zero.

The blade 220B has a bit operand 230B. The bit operand 230B may be generated from the blade 220B, e.g., by the bit operand generator 120 in FIG. 1. The bit operand 230B has 5 bits. The bits may correspond to the five possible bases of the geometric algebraic operation: e₄, e₃, e₂, e₁, and e₀, respectively. A bit of one indicates that the corresponding base is present in the blade 220B. A bit of zero indicates that the corresponding base is absent from the blade 220B. As the blade 220B has e₄, e₃, and e₁, the first bit (corresponding to e₄), second bit (corresponding to e₃), and fourth bit (corresponding to e₁) in the bit operand 230B are one, and the third bit (corresponding to e₂) and fifth bit (corresponding to e₀) in the bit operand 230B are zero. The bit operand 230A and bit operand 230B can be used to compute a sign of the geometric product 240, e.g., by the hardware accelerator 140 in FIG. 1.

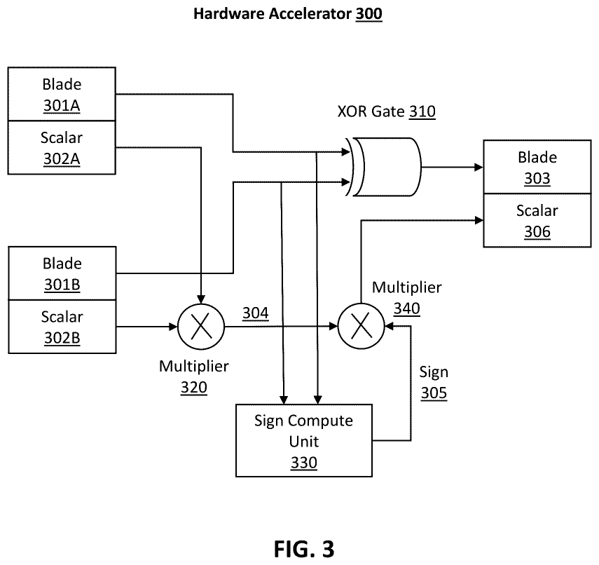

FIG. 3 illustrates a hardware accelerator 300, in accordance with various embodiments. The hardware accelerator 300 may execute geometric algebraic operations, including multiplications of blades. The hardware accelerator 300 may be an example of the hardware accelerator 140 in FIG. 1. As shown in FIG. 3, the hardware accelerator 300 includes a XOR gate 310, a multiplier 320, a sign compute unit 330, and another multiplier 340. In other embodiments, alternative configurations, different or additional components may be included in the hardware accelerator 300. Further, functionality attributed to a component of the hardware accelerator 300 may be accomplished by a different component included in the hardware accelerator 300 or a different device.

For the purpose of illustration, the hardware accelerator 300 receives a blade 301A, scaler 302A, blade 301B, and scalar 302B in FIG. 3. The blade 301A and scaler 302A may be included in a first blade, the blade 301B and scalar 302B may be in a second blade, and the hardware accelerator 300 may perform a multiplication of the first blade and the second blade. As shown in FIG. 3, the blade 301A and blade 301B are provided to the XOR gate 310. The XOR gate 310 computes a blade 303 from the blade 301A and blade 301B. The scaler 302A and scalar 302B are provided to the multiplier 320. The 320 multiplies the scaler 302A and scalar 302B and computes a scaler 304. The scaler 304 is the product of the scaler 302A and scalar 302B.

The blade 301A and blade 301B are also provided to the sign compute unit 330. The 330 computes a sign 305, e.g., by implementing one or more sign computation algorithms, such as the ones described above. The sign 305 and scaler 304 are provided to the multiplier 340. The multiplier 340 computes a scalar 306. The scalar 306 has the sign 305 and an absolute value that equals the value of the scaler 304. The blade 303 and scalar 306 may constitute the output of the hardware accelerator 300, which is a result of the geometric algebraic operation.

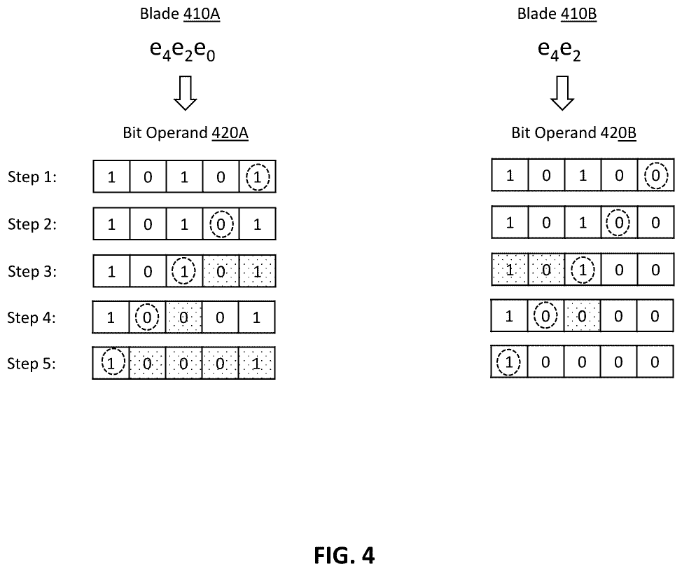

FIG. 4 illustrates an example sign computation, in accordance with various embodiments. For the purpose of illustration, FIG. 4 shows a multiplication of a blade 410A and another blade 410B. The blade 410A has a bit operand 420A, which may be generated from the blade 410A by the bit operand generator 120. The blade 410B has a bit operand 420B, which may be generated from the blade 410B by the bit operand generator 120. In the embodiments of FIG. 4, n=p=4, so each of the bit operand 420A and bit operand 420B has five bits corresponding to e₀, e₁, e₂, e₃, e₄, and e₅, respectively.

FIG. 4 shows five steps performed for the sign computation. In step 1, the last bit in each of the bit operand 420A and bit operand 420B is detected. There is no match as the last bit in bit operand 420A is a high bit (i.e., 1) but the last bit in bit operand 420B is a low bit (i.e., 0), which indicates that the corresponding base (i.e., e₀) in the blade 410A is not in the blade 410B. There is no sign change. In step 2, the second last bit in each of the bit operand 420A and bit operand 420B is detected. There is no match, so there is no sign change. In step 3, the third bit in each of the bit operand 420A and bit operand 420B is detected. There is a match, indicating that both the blade 410A and the blade 410B have the corresponding base (i.e., e₂). Next, the number N of high bits between the matching bits is determined. N may indicate the amount of swaps that are needed to take the desired bases to the contraction position. The bits between the matching bits include the last two bits of the bit operand 420A and the first two bits of the bit operand 420B, which are highlighted by a dot pattern in FIG. 4. These four bits include two high bits and two low bits, so N=2. As N is an even number, there is no sign change.

In step 4, the second bit in each of the bit operand 420A and bit operand 420B is detected. There is no match, so there is no sign change. The third bit (highlighted by a dot pattern in FIG. 4) in each of the bit operand 420A and bit operand 420B is changed to a low bit in step 4, as the corresponding base (i.e., e₂) is contracted and can therefore be eliminated. The bit operand 420A and bit operand 420B can therefore be updated in step 3 or step 4.

In step 5, the first bit in each of the bit operand 420A and bit operand 420B is detected. There is a match, indicating that both the blade 410A and the blade 410B have the corresponding base (i.e., e₄). Next, the number N of high bits between the matching bits is determined. N may indicate the amount of swaps that are needed to take the desired bases to the contraction position. The bits between the matching bits include the last four bits of the bit operand 420A, which are highlighted by a dot pattern in FIG. 4. These four bits include one high bit and three low bits, so N=1. As N is an odd number, there is a sign change. In some embodiments, e₀²=e₁²=e₂²=e₃²=e₄²=1, the resulting blade is −e₀.

Step 5 may be the last step in the sign computation. The total number of steps in the sign computation equals n. The sign computation algorithm shown in FIG. 4 may be implemented by a hardware accelerator, such as the hardware accelerator 140 or hardware accelerator 300 (more specifically, the sign compute unit 330 in the hardware accelerator 300). The sign compute unit 330 may have various architectures in various embodiments.

FIGS. 5A-5G illustrate a sign compute unit 500 with a mask decoder 520 and one-hot decoder 530, in accordance with various embodiments. The sign compute unit 500 is shown in FIG. 5G, and FIGS. 5A-5F shows various portions of the sign compute unit 500. In other embodiments, alternative configurations, different or additional components may be included in the sign compute unit 500. Also, functionality attributed to a component of the sign compute unit 500 may be accomplished by a different component included in the sign compute unit 500 or a different device.

FIG. 5A shows a counter 510 in addition to the mask decoder 520 and one-hot decoder 530. In some embodiments, the sign compute unit 500A may directly map a sign computation algorithm (e.g., the sign computation algorithm described above in conjunction with FIG. 4) to compute signs of geometric products. The architecture of the sign compute unit 500A may facilitate a sequential approach, aiming to sweep through each of the bases that make up the blades. During this process, the sign compute unit 500A can examine all possible scenarios involving sign changes that may arise from the contractions, swaps, and reordering associated with the current base. This base sweep can be achieved by using the one-hot decoder 530 that can support an operation of iterating across all the bases. The counter 510, which includes a clock 515, may control the timing of a plurality of clock cycles in the operation. With the counter 510, mask decoder 520, and one-hot decoder 530, the rights bits can be identified form the bit operand 420A and bit operand 420B for performing the five steps in the sign computation.

In some embodiments, the one-hot decoder 530 may generate a mask 535 having a width of 2n. In an example of n=p+q=5, the width of the mask 535 is 10, as shown in FIG. 5A. There are 10 bits in each row of the mask 535. Out of the 10 bits, two bits are high bits and the other bits are low bits. The mask 535 may be used as a filtering mask by the mask decoder 520. The mask decoder 520 may apply the mask 535 on bit operands to identify bits in each step of the sign computation. The bits identified in a step may correspond to the bases that are evaluated in the step. In some embodiments, the mask decoder 520 may apply a single row the mask 535 on two bit operands for the two blades in a geometric algebra multiplication to identify two bits from the two bit operands, respectively. The mask decoder 520 may use a different row of the mask 535 in each of the clock cycles controlled by the counter 510. In the example shown in FIG. 5A, the mask 535 has five rows, and there may be five clock cycles. Taking the bit operand 420A and bit operand 420B in FIG. 4 for example, the five steps may be performed in the five clock cycles, respectively. In each clock cycle, the mask decoder 520 may apply the corresponding row of the mask 535 on the bit operand 420A and bit operand 420B to identify two bits, which are the bits circled by dash ovals in FIG. 5A.

FIG. 5B shows, in addition to the components of the sign compute unit 500 shown in FIG. 5A, a circuitry to match checking, mask, filter and identify the obstacle bases to perform a contraction. FIG. 5B shows a register 540 that can store at least 2n bits. The bit operand 420A and bit operand 420B may be stored in the register 540. For instance, the bit operand 420A may be stored to the most significant part (marked by “A” in FIG. 5B) of the register 540, and the bit operand 420B may be stored to the least significant part (marked by “B” in FIG. 5B) of the register. After the bit operand 420A and bit operand 420B are stored in the register, the one-hot decoder 530 may then generate the mask 535 for iterating over each one of the bases to look for a match, e.g., by using AND gates 560A and 560B. An AND gate is also referred to as an AND logic gate. In some embodiments, the mask decoder 520 may use the mask 535 to filter out to filter out the n−1 bits between the two identified bits corresponding to the current evaluated base(s). This way, the sign compute unit 500 can determine the number of bases that are between the two sides of the currently evaluated base(s).

FIG. 5C additionally shows parity-checking hardware, a parity block 550, which can filter the needed swaps to perform a base contraction. The parity block 550 can be used to determine the parity of the resulting bit chain to determine whether any sign changes are needed from the swapping process to make a contraction operation. In some embodiments, the parity block 550 may operate when a match is detected from the previous stage and may be idle when no match is detected. Another AND gate 560C is also added for processing the output of the AND gate 560A and the parity block 550.

FIG. 5D additionally shows hardware in the sign compute unit 500 to perform sign accumulation across n cycles. As described above, an odd parity may lead to sign change, while an even parity may keep the sign. In some embodiments, the sign compute unit 500 may perform a sign accumulation throughout the n computation cycles by performing an XOR operation, by using a XOR gate 570A, with the sign itself. The sign may be stored in a sign register 580, which has a clock 585. The sign register 580 may be updated with the result of the sign accumulation after the sign accumulation is done in each computation cycle. The computation cycle may be at least partially controlled by the clock 585.

FIG. 5E shows a feedback loop to the register 540 to remove bases that match. In FIG. 5E, the sign compute unit 500 also includes an XOR gate 570B coupled to the register 540 and the one-hot decoder 530. The XOR gate 570B may receive outputs of the mask decoder 520 and register 540, which generates the feedback loop for the register 540 that allows the removal of the matching bases. The register 540 may be updated to store the bits in the updated bit operand 420A or updated bit operand 420B.

FIG. 5F additionally shows hardware to determine whether the base contracts to 1 or −1. After contractions are performed, the sign compute unit 500 may determine whether the base contracts to 1 or −1. For instance, the sign compute unit 500 may identify the conditions needed to make this happen, e.g., a match in the currently evaluated base in both of the bit operand 420A and bit operand 420B, and the current matching base index belongs to the negative range q. In other words, bᵢ∀i∈[p, p+q−1]. The first condition may have been met from the previous stage, which is described above in conjunction with FIG. 5E or even earlier. The sign compute unit 500 may check for the range of the matching indexes. An AND gate 560D in the sign compute unit 500 may check for the meet and drive the output to another XOR gate 570C in the sign compute unit 500. The AND gate 560D receives a mask 501, the output from the one-hot decoder 530, and the output of the AND gate 560A. This may negate the previously computed sign from the contraction stage. The mask 501 may be a (p,q) mask denoted as [11 . . . 1 00 . . . 0].

FIG. 5G shows an additional AND gate 560E. The sign compute unit 500 may complete all the swaps to contract bases. In some embodiments, the sign compute unit 500 may also do additional swapping to rearrange the order of bases. There may be two situations where the sign compute unit 500 performs additional swapping: either to move a base to its final position for contraction or to reorder a base that has not been contracted. The sign compute unit 500 can determine whether either of the two scenarios apply by using at least the AND gate 560E and the XOR gate 570B. In some embodiments, when there is a ‘1’ in the bit operand 420B, the sign compute unit 500 account for the parity of the in-between bits, either for performing a contraction or for taking it to its final place by reordering. The sign compute unit 500 may determine whether a base matches and can be contracted. Alternatively or additionally, the sign compute unit 500 may determine whether there is a base in the bit operand 420B that has not been contracted yet and needs to be moved to a new position.

With the components in the sign compute unit 500, the sign compute unit 500 can address various situations that could lead to a change in sign. The sign compute unit 500 can process and determine sign changes within n=p+q cycles. In some embodiments, the sign compute unit 500 may iterate over each base once.

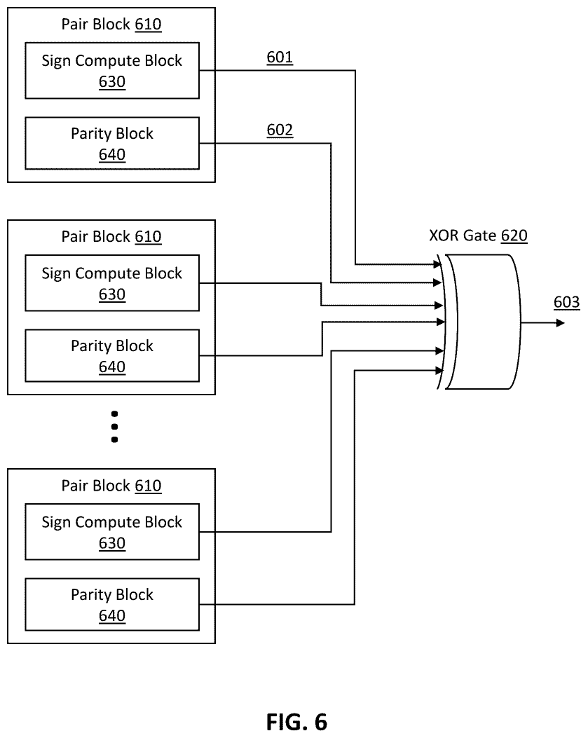

FIG. 6 illustrates a sign compute unit 600 including sign compute blocks 630 paired with parity blocks 640, in accordance with various embodiments. The sign compute unit 600 may be an example of the sign compute unit 330 in FIG. 3. The sign compute blocks 630 are individually referred to as sign compute block 630. The parity blocks 640 are individually referred to as parity block 640. Each sign compute block 630 pairs with a parity block 640, and the sign compute block 630 and the parity block 640 constitutes a pair block 610. The sign compute unit 600 also includes an XOR gate 620. In other embodiments, the sign compute unit 600 may include fewer, more, or different components. For instance, even though FIG. 6 shows more than three pair blocks 610, the sign compute unit 600 may include a single pair block 610 or two or three pair blocks 610 in other embodiments.

In some embodiments, the sign compute unit 600 may determine signs of products for geometric algebraic operations with a parameter n and adjustable parameters p and q, where n=p+q. The sign compute unit 600 can determine resulting signs of various n-dimensional algebra. For instance, the sign compute unit 600 may compute for any combination of p, q where the sum of them is less or equal to n. In an example, each parity block 640 may compute a sign 601 from two bit operands for two blades in a geometric algebraic operation. The parity block 640 may output a parity signal 602 that indicates whether the sign 601 needs to be changed. The sign 601 and parity signal 602 from each pair block 610 are provided to the XOR gate 620. The XOR gate 620 may compute a final sign 603 form the signs and parity signals from the pair blocks 610. The final sign 603 may be the sign of the geometric product of the two blades.

In some embodiments, a sign compute block 630 may be a n-bit sized sign compute block configured to process n-bit operands, i.e., bit operands having lengths of n. The n-bit sized sign compute block may process 2n bits at a time. The 2n bits may be the bits in two n-bit operands. The sign compute unit 600 may include a single n-bit sized sign compute block. Alternatively, the sign compute unit 600 may include multiple n-bit sized sign compute blocks, e.g., h n-bit sized sign compute block, where h is an integer greater than 1, so that the sign compute unit 600 can process h×2n bits at a time. The sign compute unit 600 may be used for geometric algebraic operations with vector space dimensions larger than n.

In other embodiments, a sign compute block 630 may be a l-bit sized sign compute block configured to process l-bit operands, i.e., bit operands having lengths of l, where l is an integer that is smaller than n. For instance, n may be a multiple of l. The sign compute unit 600 may include a single l-bit sized sign compute block and perform sign computations for any arbitrary n-dimensional space by sequentially using the l-bit sized sign compute block, e.g., in software. Alternatively, the sign compute unit 600 may have m l-bit sized sign compute blocks, where n=m×l. The l-bit sized sign compute blocks may be interconnected to build an arbitrary n-dimensional sign compute hardware. The sign compute unit 600 may sweep through a n-bits blade with step size=l. The resulting parity may be transferred through all m blocks. Given the already-mentioned flexibility property, provided by the adjustable p and q parameters, this can result in the capability of handling algebras of any n=m*l dimensions. The architecture of the sign compute unit 600 can be scalable to arbitrary geometric algebras.

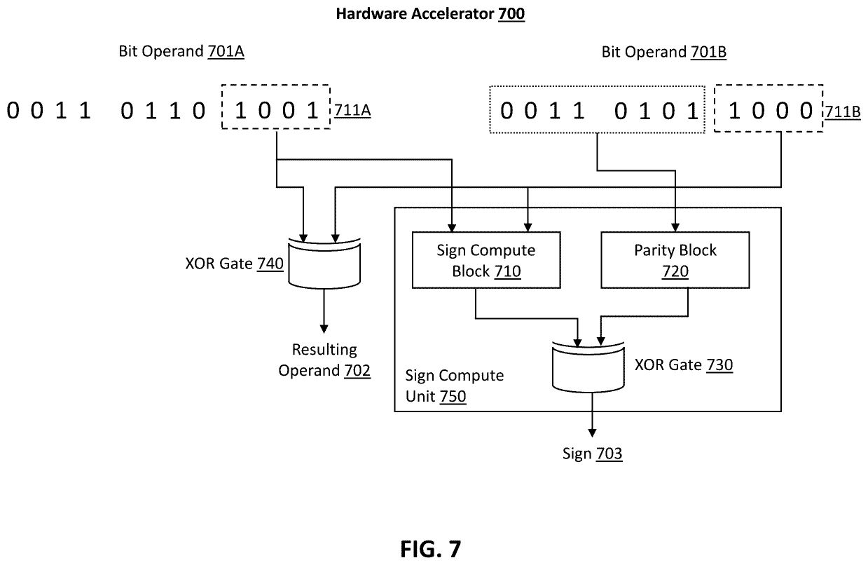

FIG. 7 illustrates a hardware accelerator 700 including a 4-bit sized sign compute block 710, in accordance with various embodiments. The hardware accelerator 700 may be an example of the hardware accelerator 140 in FIG. 1 or the hardware accelerator 300 in FIG. 3. The sign compute block 710 may be an example of the sign compute block 630 in FIG. 6. The sign compute block 710 may include some of the components in the sign compute unit 500 shown in FIG. 5G, such as the counter 510, mask decoder 520, one-hot decoder 530, one or more AND gates, one or more XOR gates, or some combination thereof. The hardware accelerator 700 also includes a parity block 720, an XOR gate 730, and another XOR gate 740. The sign compute block 710, parity block 720, and XOR gate 730 constitutes at least part of a sign compute unit 750, which may be an example of the sign compute unit 330 in FIG. 3. In other embodiments, the hardware accelerator 700 may include fewer, more, or different components.

For the purpose of illustration, the hardware accelerator 700 receives two bit operands 701A and 701B. The bit operand 701A may correspond to a blade in a geometric algebraic operation, and the bit operand 701B may correspond to another blade in the geometric algebraic operation. The geometric algebraic operation may include a multiplication of the two blades. The geometric algebraic operation may have n=12. Each of the bit operands 701A and 701B has 12 bits that corresponds to the 12 bases of the geometric algebraic operation. A high bit (i.e., 1) indicates that the corresponding base is included in the blade, while a low bit (i.e., 0) indicates that the corresponding base is not included in the blade.

The hardware accelerator 700 may sweep through the bit operands 701A and bit operands 701B for computing the geometric product of the two blades. In an example, each of the bit operands 701A and 701B is partitioned into three smaller bit operands, each of which has 4 bits to match the size of the sign compute block 710. The six 4-bit operands may be processed in three computation cycles. In the first computation cycle, a 4-bit operand 711A in the bit operand 701A and a 4-bit operand 711B in the bit operand 701B are input into the XOR gate 740 to compute a resulting operand 702. The resulting operand 702 may be 0001. The resulting operand 702 is a bit operand of the resulting blade, i.e., a blade resulted from multiplying the two blades represented by the 4-bit operand 711A and 4-bit operand 711B.

The 4-bit operand 711A and 4-bit operand 711B are also input into the sign compute unit 750, which determines a sign 703. In some embodiments, the sign compute block 710, and the sign compute block 710 computes a sign from them. The other eight bits in the bit operand 701B (i.e., 00110101) are input into the parity block 720 to determine the parity, as these eight bits are the bits between the 4-bit operand 711A and 4-bit operand 711B. In the example shown in FIG. 7, as the eight bits include four high bits, there is an even parity, so the sign determined by the sign compute block 710 is kept by the XOR gate 730. The sign compute unit 750 outputs a sign 703, which is the sign 703 output from the sign compute block 710.

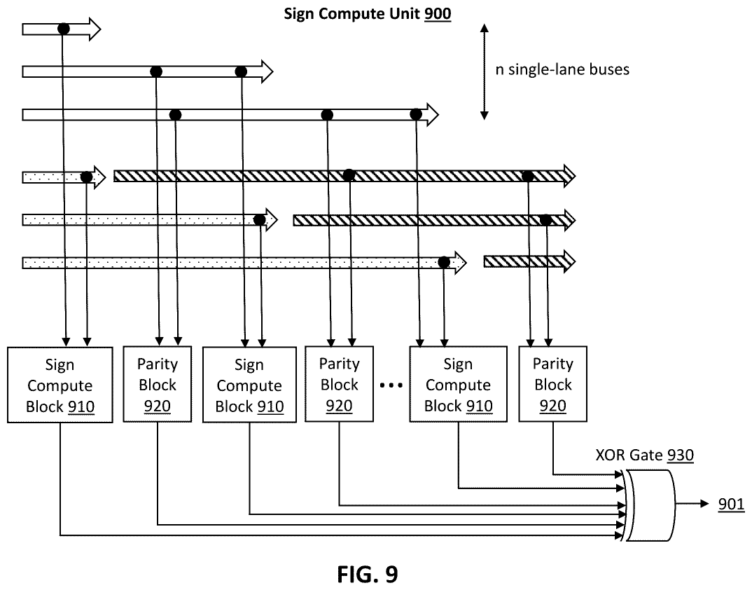

Even though not shown in FIG. 7, after the XOR gate 740 computes the resulting operand 702, the 4-bit operand 711A may be substituted with the resulting operand 702. For instance, a register (or a portion of a register) that stores the bit operand 701A may be updated to replace the 4-bit operand 711A with the resulting operand 702. The 4-bit operand 711B may remain the same. For instance, a register (or a portion of a register) that stores the bit operand 701B may be unchanged. For subsequent computation cycles, this new configuration may be part of the bases situated between. Certain aspects of this new configuration are described below in conjunction with FIG. 9.

In the second computation cycle, the 4-bit operand in the middle of the bit operand 701A and the 4-bit operand in the middle of the bit operand 701B are processed by the XOR gate 740, which compute a new resulting operand. This new resulting operand may replace the 4-bit operand in the middle of the bit operand 701A, while the 4-bit operand in the middle of the bit operand 701B may remain the same. The 4-bit operand in the middle of the bit operand 701A and the 4-bit operand in the middle of the bit operand 701B are also processed by sign compute block 710, which compute a sign. The resulting operand 702 (which has replaced the 4-bit operand 711A) and the most left 4-bit operand in the bit operand 701B may be input into the parity block 720 for determining parity in the second computation cycle.

In the third computation cycle, the most left 4-bit operand in the bit operand 701A and the most left 4-bit operand in the bit operand 701B are processed by the XOR gate 740 for computing another resulting operand. The most left 4-bit operand in the bit operand 701A and the most left 4-bit operand in the bit operand 701B are also processed by the sign compute block 710 for computing another sign. The two resulting operands, which were computed in the first computation cycle and the second computation cycle, may be input into the parity block 720 for determining parity. The outputs of the XOR gate 740 and sign compute unit 750 from each computation cycle may be combined to produce the geometric product of the two blades.

Even though FIG. 7 shows a single sign computer block and a single parity block, in other embodiments, the sign compute unit 750 may include multiple sign compute blocks or parity blocks, such as three sign compute blocks or three parity blocks. In an example where the sign compute unit 750 has three sign compute blocks and three parity blocks, each pair of a sign compute block and a parity block may process a different one of the three 4-bit operands in each of the bit operands 701A and 701B. The three sign compute blocks and three parity blocks may operate in the same computation cycle to finish the sign computation within the same computation cycle.

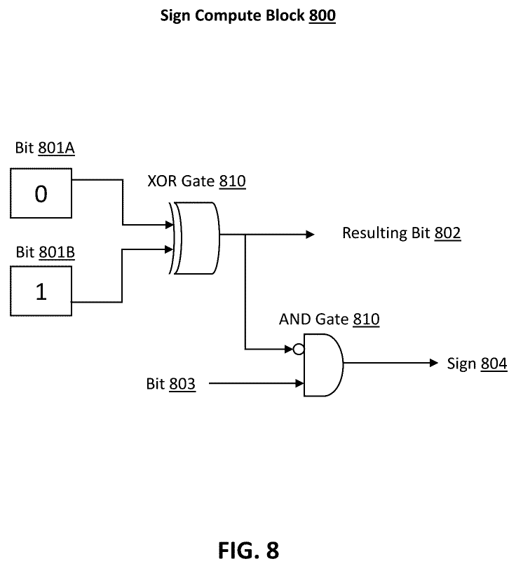

FIG. 8 illustrates a sign compute block 800, in accordance with various embodiments. The sign compute block 800 may be a 1-bit sized sign compute block. The sign compute block 800 may be an example of the sign compute blocks 630 in FIG. 6. In the embodiments of FIG. 8, the sign compute block 800 includes an XOR gate 810 and an AND gate 820. In other embodiments, the sign compute block 800 may include fewer, more, or different components.

For the purpose of illustration, the sign compute block 800 receives a bit 801A and a bit 801B in FIG. 8. The bit 801A may be in a bit operand representing a blade of a geometric algebraic operation. The bit 801B may be in a bit operand representing another blade of the geometric algebraic operation. The bit 801A and bit 801B may each represent a base. The XOR gate 810 performs an XOR operation on the bit 801A and bit 801B and computes a resulting bit 802. In some embodiments, the resulting bit 802 may replace the bit 801A, e.g., in a register where the bit 801A is stored. The resulting bit 802 is input into the gate 820. The gate 820 also receives another signal, i.e., a bit 803. The bit 803 may be 0 when it is p bases, i.e., the square of a base is 1. The bit 803 may be 1 when it is q bases, i.e., the square of a base is −1. The gate 820 outputs a sign 804.

Even though not shown in FIG. 8, the sign compute block 800 may be coupled to a parity block, such as one of the parity block 640s in FIG. 6, to constitute a 1-bit sized sign compute unit. The 1-bit sized sign compute unit may be used to build any n-dimensional sign compute units. For instance, five such 1-bit sized sign compute units can be coupled together to constitute a 5-bit sized sign compute unit, or 12 such 1-bit sized sign compute units can be coupled together to constitute a 12-bit sized sign compute unit.

The architecture of the sign compute block 800 can provide more advantageous scalability and flexibility, compared with currently available technologies. Using the 1-bit sized sign compute block is a novel, nontrivial approach that can provide multiple benefits and improvements. For instance, using the 1-bit sized sign compute block makes it easier to build any n dimensional algebra given that every n is divisible by one, therefore one size can fit any algebra. Also, swapping can be avoided. When comparing 1-1 blades, there would be no need to perform any swaps for reordering or contracting bases. It can also provide less hardware complexity. Further, it requires an XOR gate and an AND gate to compute sign for 1 bit along with one or more negative logic gates (also referred to as negative gates) to check whether the contractions go positive or negative. One or more XOR gates may be used as the parity block.

FIG. 9 illustrates a sign compute unit 900 with a cascade block topology, in accordance with various embodiments. The sign compute unit 900 may be an example of the sign compute unit 330 in FIG. 3 or the sign compute unit 600 in FIG. 6. As shown in FIG. 9, the sign compute unit 900 includes sign compute blocks 910 (individually referred to as “sign compute block 910”), parity blocks 920 (individually referred to as “parity block 920”), and an XOR gate 930. Each sign compute block 910 is paired with a parity block 920, as shown in FIG. 9. In some embodiments, the sign compute unit 900 can determine signs of multiplication products of n-dimensional blades. A sign compute block 910 may be configured to process l-bit operands, where l is an integer that is smaller than n. The number of sign compute blocks or parity blocks in the sign compute unit 900 may be n divided by l. In an example where n=12 and l=1, the sign compute unit 900 may include 12 sign compute blocks 910 paired with 12 parity blocks 920, respectively, which has a cascade, sequential topology. The XOR gate 930 receives outputs of the sign compute blocks 910 and the parity blocks 920 and outputs a sign 901.

The sign compute unit 900 may include or be associated with n single-lane buses for transmitting bits to the sign compute blocks 910 and parity blocks 920, as illustrated by the vertical arrows in FIG. 9. The horizontal arrows in FIG. 9 represent bit operands of blades. The horizontal arrows with no filling pattern may be the bit operand of a blade (Blade A), which to be multiplied by another blade (Blade B) whose bit operand is represented by the horizontal arrows filled with dots. The horizontal arrows filled with diagonal strips represent the bit operand of the resulting blade. The sign compute blocks 910 receives bits from the bit operands of Blade A and Blade B. The parity blocks 920 receives bits from the bit operands of Blade A, Blade B, and the resulting blade. During the computation of the sign 901, bits in the bit operand of Blade A may be replaced by bits in the bit operand of the resulting blade.

By integrating the sign compute block architecture shown in FIG. 8 within the cascade block topology shown in FIG. 9, the hardware can be significantly simplified by sticking to the use of logic gates (mainly XOR gates), which can reduce the execution time and area. In some embodiments, a n-dimensional sign compute unit can be built up by wiring a cascade topology with a plurality of XOR gates and a plurality of AND gates.

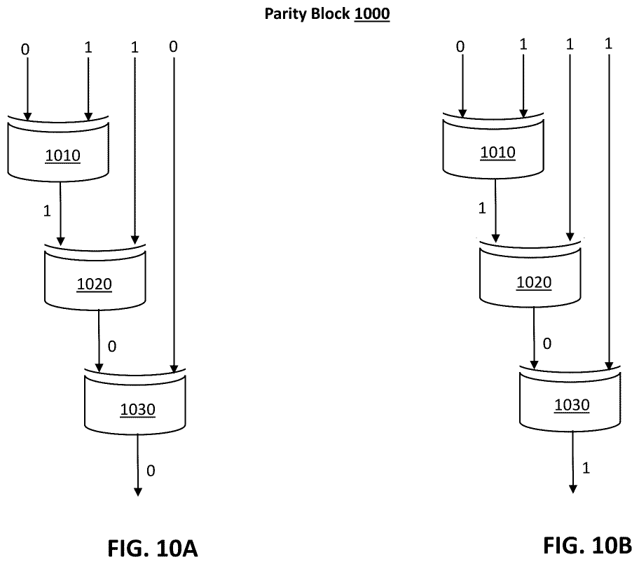

FIGS. 10A and 10B illustrate a parity block 1000, in accordance with various embodiments. The parity block 1000 includes three XOR gates 1010, 1020, and 1030. The parity block 1000 may be paired with a 4-bit sized sign compute block, such as the 4-bit sized sign compute block 710 in FIG. 7. In other embodiments, the parity block 1000 may include fewer or more XOR gates or different components.

As an example, the parity block 1000 receives four bits 0110 in FIG. 10A. The XOR gate 1010 receives two of the four bits, 01, and performs an XOR operation, which results in a new bit 1. The XOR gate 1020 receives the new bit output by the XOR gate 1010 and the third bit in the original four bits and performs an XOR operations on these bits, which results in another new bit 0. The XOR gate 1030 receives the output of the XOR gate 1020 and the fourth bit in the original four bits and outputs another new bit 0. The output of the XOR gate 1030 may indicate even parity in the four bits 0110, so the sign determined by the sign compute block can remain the same.

As another example, the parity block 1000 receives four bits 0111 in FIG. 10B. The XOR gate 1010 receives two of the four bits, 01, and performs an XOR operation, which results in a new bit 1. The XOR gate 1020 receives the new bit output by the XOR gate 1010 and the third bit in the original four bits and performs an XOR operations on these bits, which results in another new bit 0. The XOR gate 1030 receives the output of the XOR gate 1020 and the fourth bit in the original four bits and outputs another new bit 1. The output of the XOR gate 1030 may indicate odd parity in the four bits 0111, so the sign determined by the sign compute block needs to be changed. For instance, when the sign determined by the sign compute block is a negative sign, it needs to be changed to a positive sign; when the sign determined by the sign compute block is a positive sign, it needs to be changed to a negative sign.

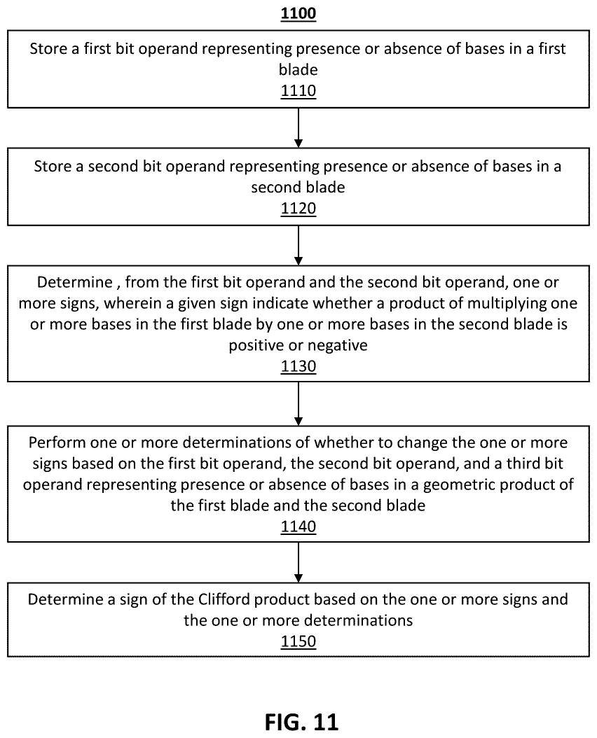

FIG. 11 is a flowchart of a method 1100 of executing a geometric algebraic operation, in accordance with various embodiments. The method 1100 may be performed by the geometric algebra system 100 in FIG. 1. Although the method 1100 is described with reference to the flowchart illustrated in FIG. 11, many other methods of executing geometric algebraic operations may alternatively be used. For example, the order of execution of the steps in FIG. 11 may be changed. As another example, some of the steps may be changed, eliminated, or combined.

The geometric algebra system 100 stores 1110 a first bit operand. The first bit operand represents presence or absence of bases in a first blade of the geometric algebraic operation. In some embodiments, the geometric algebra system 100 stores a first bit operand in a first portion of a register. In some embodiments, the geometric algebraic operation has a predetermined number of bases. The first bit operand comprises the predetermined number of bits that corresponds to the predetermined number of bases, respectively. A high bit in the first bit operand indicates that a corresponding base is present in the first blade. A low bit in the first bit operand indicates that a corresponding base is absent from the first blade.

The geometric algebra system 100 stores 1120 a second bit operand. The second bit operand represents presence or absence of bases in a second blade of the geometric algebraic operation. In some embodiments, the geometric algebra system 100 stores a second bit operand in a second portion of a register. In some embodiments, the geometric algebraic operation has a predetermined number of bases. The second bit operand comprises the predetermined number of bits that corresponds to the predetermined number of bases, respectively. A high bit in the second bit operand indicates that a corresponding base is present in the second blade. A low bit in the second bit operand indicates that a corresponding base is absent from the second blade.

The geometric algebra system 100 determines 1130, from the first bit operand and the second bit operand, one or more signs. A given sign indicates whether a product of multiplying one or more bases in the first blade by one or more bases in the second blade is positive or negative. In some embodiments, the geometric algebra system 100 generates a mask comprising a plurality of bit sequences. A bit sequence comprises a single high bit and one or more low bits. The geometric algebra system 100 filters out two bits from the first bit operand and the second bit operand by applying the mask on the first bit operand and the second bit operand. The geometric algebra system 100 determines the one or more signs based on the two bits.

The geometric algebra system 100 performs 1140 one or more determinations of whether to change the one or more signs based on the first bit operand, the second bit operand, and a third bit operand representing presence or absence of bases in a geometric product of the first blade and the second blade. In some embodiments, a register stores the first bit operand and the second bit operand. The register is updated by replacing one or more bits in the first bit operand with one or more bits in the third bit operand.

The geometric algebra system 100 determines 1150 a sign of the geometric product based on the one or more signs and the one or more determinations. In some embodiments, the geometric algebra system 100 performs an XOR operation on signals encoding the one or more signs and the one or more determinations.

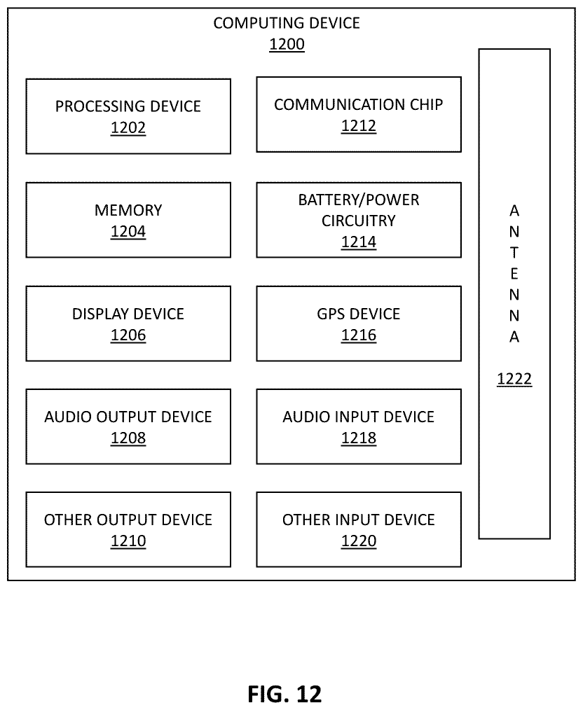

FIG. 12 is a block diagram of an example computing device 1200, in accordance with various embodiments. In some embodiments, the computing device 1200 can be used as at least part of the geometric algebra system 100. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208 but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for executing geometric algebraic operations (e.g., the method 1100 described in conjunction with FIG. 11) or some operations performed by one or more components of the geometric algebra system 100 (e.g., the hardware accelerator 140). The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

The following paragraphs provide various examples of the embodiments disclosed herein.

Example 1 provides an apparatus for executing a geometric algebraic operation, the apparatus including one or more sign compute blocks to: receive a first bit operand representing presence or absence of bases in a first blade and a second bit operand representing presence or absence of bases in a second blade, and determine, from the first bit operand and the second bit operand, one or more signs, in which a given sign indicate whether a product of multiplying one or more bases in the first blade by one or more bases in the second blade is positive or negative; one or more parity blocks respectively paired with the one or more sign compute blocks, a parity block to determine whether to change a sign determined by a sign compute block with which the parity block is paired; and an XOR logic gate coupled to the one or more sign compute blocks and the one or more parity blocks for generating an output signal from outputs of the one or more sign compute blocks and the one or more parity blocks, the output signal indicating a sign of a geometric product of the first blade and the second blade.

Example 2 provides the apparatus of example 1, further including one or more XOR gates to compute a third bit operand, the third bit operand representing presence or absence of bases in the geometric product.

Example 3 provides the apparatus of example 2, further including a register to store the first bit operand and the second bit operand, in which the register is updated by replacing one or more bits in the first bit operand with one or more bits in the third bit operand.

Example 4 provides the apparatus of any one of examples 1-3, in which the geometric algebraic operation has a predetermined number of bases, and the first bit operand or the second bit operand has the predetermined number of bits.

Example 5 provides the apparatus of example 4, in which the predetermined number of bits in the first bit operand respectively corresponds to the predetermined number of bases, a high bit in the first bit operand indicating that a corresponding base is present in the first blade, a low bit in the first bit operand indicating that a corresponding base is absent from the first blade.

Example 6 provides the apparatus of any one of examples 1-5, in which a sign compute block includes another XOR logic gate and an AND logic gate.

Example 7 provides the apparatus of any one of examples 1-6, in which a sign compute block is to receive a bit in the first bit operand and a bit in the second bit operand in a computation cycle.

Example 8 provides the apparatus of any one of examples 1-7, in which a sign compute block includes a one-hot decoder to generate a mask including a plurality of bit sequences, a bit sequence including a single high bit and one or more low bits; and a mask decoder to filter out two bits from the first bit operand and the second bit operand by applying the mask on the first bit operand and the second bit operand.

Example 9 provides the apparatus of any one of examples 1-8, in which the sign is determined by the sign compute block with which the parity block is paired based on one or more bits in the first bit operand, and the parity block is to determine whether to change the sign determined by the sign compute block based on one or more other bits in the first bit operand.

Example 10 provides the apparatus of any one of examples 1-9, in which the parity block includes a first XOR logic gate and a second XOR logic gate, in which an output of the first XOR logic gate is an input of the second XOR logic gate.

Example 11 provides an apparatus for executing a geometric algebraic operation, the apparatus including a register including a first portion and a second portion, the first portion to store a first bit operand representing presence or absence of bases in a first blade, the second portion to store a second bit operand representing presence or absence of bases in a second blade; one or more sign compute blocks to determine, from the first bit operand and the second bit operand, one or more signs, in which a given sign indicate whether a product of multiplying one or more bases in the first blade by one or more bases in the second blade is positive or negative; one or more parity blocks respectively paired with the one or more sign compute blocks, a parity block to determine whether to change a sign determined by a sign compute block with which the parity block is paired; and an XOR logic gate coupled to the one or more sign compute blocks and the one or more parity blocks for generating an output signal from outputs of the one or more sign compute blocks and the one or more parity blocks, the output signal indicating a sign of a geometric product of the first blade and the second blade.

Example 12 provides the apparatus of example 11, further including one or more XOR gates to compute a third bit operand, the third bit operand representing presence or absence of bases in the geometric product, in which the first portion of the register is updated by replacing one or more bits in the first bit operand with one or more bits in the third bit operand.

Example 13 provides the apparatus of example 11 or 12, in which the geometric algebraic operation has a predetermined number of bases, the first bit operand or in the second bit operand includes the predetermined number of bits that respectively correspond to the predetermined number of bases, a high bit in the first bit operand indicates that a corresponding base is present in the first blade, and a low bit in the first bit operand indicates that a corresponding base is absent from the first blade.

Example 14 provides the apparatus of any one of examples 11-13, in which a sign compute block includes another XOR logic gate and an AND logic gate.

Example 15 provides the apparatus of any one of examples 11-14, in which a sign compute block is to receive a bit from the first portion of the register and to receive a bit from the second portion of the register in a computation cycle.

Example 16 provides the apparatus of any one of examples 1-10, in which a sign compute block includes a one-hot decoder to generate a mask including a plurality of bit sequences, a bit sequence including a single high bit and one or more low bits; and a mask decoder to filter out two bits from the first bit operand and the second bit operand by applying the mask on the first bit operand and the second bit operand.

Example 17 provides the apparatus of any one of examples 1-16, in which the sign is determined by the sign compute block with which the parity block is paired based on one or more bits in the first bit operand, and the parity block is to determine whether to change the sign determined by the sign compute block based on one or more other bits in the first bit operand.

Example 18 provides a method for executing a geometric algebraic operation, the method including storing a first bit operand representing presence or absence of bases in a first blade; storing a second bit operand representing presence or absence of bases in a second blade; determining, from the first bit operand and the second bit operand, one or more signs, in which a given sign indicates whether a product of multiplying one or more bases in the first blade by one or more bases in the second blade is positive or negative; performing one or more determinations of whether to change the one or more signs based on the first bit operand, the second bit operand, and a third bit operand representing presence or absence of bases in a geometric product of the first blade and the second blade; and determining a sign of the geometric product based on the one or more signs and the one or more determinations.

Example 19 provides the method of example 18, in which the geometric algebraic operation has a predetermined number of bases, the first bit operand includes the predetermined number of bits that respectively corresponds to the predetermined number of bases, a high bit in the first bit operand indicates that a corresponding base is present in the first blade, and a low bit in the first bit operand indicates that a corresponding base is absent from the first blade.

Example 20 provides the method of example 18 or 19, in which determining the one or more signs includes generating a mask including a plurality of bit sequences, a bit sequence including a single high bit and one or more low bits; filtering out two bits from the first bit operand and the second bit operand by applying the mask on the first bit operand and the second bit operand; and determining the one or more signs based on the two bits.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An apparatus for executing a geometric algebraic operation, the apparatus comprising:
one or more sign compute blocks to:
receive a first bit operand representing presence or absence of bases in a first blade and a second bit operand representing presence or absence of bases in a second blade, and
determine, from the first bit operand and the second bit operand, one or more signs, wherein a given sign indicate whether a product of multiplying one or more bases in the first blade by one or more bases in the second blade is positive or negative;
one or more parity blocks respectively paired with the one or more sign compute blocks, a parity block to determine whether to change a sign determined by a sign compute block with which the parity block is paired; and
an XOR logic gate coupled to the one or more sign compute blocks and the one or more parity blocks for generating an output signal from outputs of the one or more sign compute blocks and the one or more parity blocks, the output signal indicating a sign of a geometric product of the first blade and the second blade.

2. The apparatus of claim 1, further comprising:
one or more XOR gates to compute a third bit operand, the third bit operand representing presence or absence of bases in the geometric product.

3. The apparatus of claim 2, further comprising:
a register to store the first bit operand and the second bit operand, wherein the register is updated by replacing one or more bits in the first bit operand with one or more bits in the third bit operand.

4. The apparatus of claim 1, wherein the geometric algebraic operation has a predetermined number of bases, and the first bit operand or the second bit operand has the predetermined number of bits.

5. The apparatus of claim 4, wherein the predetermined number of bits in the first bit operand respectively corresponds to the predetermined number of bases, a high bit in the first bit operand indicating that a corresponding base is present in the first blade, a low bit in the first bit operand indicating that a corresponding base is absent from the first blade.

6. The apparatus of claim 1, wherein a sign compute block comprises another XOR logic gate and an AND logic gate.

7. The apparatus of claim 1, wherein a sign compute block is to receive a bit in the first bit operand and a bit in the second bit operand in a computation cycle.

8. The apparatus of claim 1, wherein a sign compute block comprises:
a one-hot decoder to generate a mask comprising a plurality of bit sequences, a bit sequence comprising a single high bit and one or more low bits; and
a mask decoder to filter out two bits from the first bit operand and the second bit operand by applying the mask on the first bit operand and the second bit operand.

9. The apparatus of claim 1, wherein the sign is determined by the sign compute block with which the parity block is paired based on one or more bits in the first bit operand, and the parity block is to determine whether to change the sign determined by the sign compute block based on one or more other bits in the first bit operand.

10. The apparatus of claim 1, wherein the parity block comprises a first XOR logic gate and a second XOR logic gate, wherein an output of the first XOR logic gate is an input of the second XOR logic gate.

11. An apparatus for executing a geometric algebraic operation, the apparatus comprising:
a register comprising a first portion and a second portion, the first portion to store a first bit operand representing presence or absence of bases in a first blade, the second portion to store a second bit operand representing presence or absence of bases in a second blade;
one or more sign compute blocks to determine, from the first bit operand and the second bit operand, one or more signs, wherein a given sign indicate whether a product of multiplying one or more bases in the first blade by one or more bases in the second blade is positive or negative;
one or more parity blocks respectively paired with the one or more sign compute blocks, a parity block to determine whether to change a sign determined by a sign compute block with which the parity block is paired; and
an XOR logic gate coupled to the one or more sign compute blocks and the one or more parity blocks for generating an output signal from outputs of the one or more sign compute blocks and the one or more parity blocks, the output signal indicating a sign of a geometric product of the first blade and the second blade.

12. The apparatus of claim 11, further comprising:
one or more XOR gates to compute a third bit operand, the third bit operand representing presence or absence of bases in the geometric product,
wherein the first portion of the register is updated by replacing one or more bits in the first bit operand with one or more bits in the third bit operand.

13. The apparatus of claim 11, wherein the geometric algebraic operation has a predetermined number of bases, the first bit operand or in the second bit operand comprises the predetermined number of bits that respectively correspond to the predetermined number of bases, a high bit in the first bit operand indicates that a corresponding base is present in the first blade, and a low bit in the first bit operand indicates that a corresponding base is absent from the first blade.

14. The apparatus of claim 11, wherein a sign compute block comprises another XOR logic gate and an AND logic gate.

15. The apparatus of claim 11, wherein a sign compute block is to receive a bit from the first portion of the register and to receive a bit from the second portion of the register in a computation cycle.

16. The apparatus of claim 1, wherein a sign compute block comprises:
a one-hot decoder to generate a mask comprising a plurality of bit sequences, a bit sequence comprising a single high bit and one or more low bits; and
a mask decoder to filter out two bits from the first bit operand and the second bit operand by applying the mask on the first bit operand and the second bit operand.

17. The apparatus of claim 1, wherein the sign is determined by the sign compute block with which the parity block is paired based on one or more bits in the first bit operand, and the parity block is to determine whether to change the sign determined by the sign compute block based on one or more other bits in the first bit operand.

18. A method for executing a geometric algebraic operation, the method comprising:
storing a first bit operand representing presence or absence of bases in a first blade;
storing a second bit operand representing presence or absence of bases in a second blade;
determining, from the first bit operand and the second bit operand, one or more signs, wherein a given sign indicates whether a product of multiplying one or more bases in the first blade by one or more bases in the second blade is positive or negative;
performing one or more determinations of whether to change the one or more signs based on the first bit operand, the second bit operand, and a third bit operand representing presence or absence of bases in a geometric product of the first blade and the second blade; and
determining a sign of the geometric product based on the one or more signs and the one or more determinations.

19. The method of claim 18, wherein the geometric algebraic operation has a predetermined number of bases, the first bit operand comprises the predetermined number of bits that respectively corresponds to the predetermined number of bases, a high bit in the first bit operand indicates that a corresponding base is present in the first blade, and a low bit in the first bit operand indicates that a corresponding base is absent from the first blade.

20. The method of claim 18, wherein determining the one or more signs comprises:
generating a mask comprising a plurality of bit sequences, a bit sequence comprising a single high bit and one or more low bits;
filtering out two bits from the first bit operand and the second bit operand by applying the mask on the first bit operand and the second bit operand; and
determining the one or more signs based on the two bits.
